(19) United States
(12) Patent Application Publication
(10) Pub. No.: US 2022/0111419 A1
(43) Pub. Date: Apr. 14, 2022

(54) PLANT MATERIAL TRIMMING DEVICE WITH CYCLONIC SEPARATOR

(71) Applicant: MOSMAN MACHINERY COMPANY, INC., NEVADA CITY, CA (US)

(72) Inventors: ANGEL RAMON TORRADO PEREZ, SAN DIEGO, CA (US); DANA ELIOT MOSMAN, BOULDER, CO (US); DONALD MOSMAN, NEVADA CITY, CA (US)

(21) Appl. No.: 17/070,710

(22) Filed: Oct. 14, 2020

(51) Int. Cl. B07B 11/06; A23N 15/00; B07B 1/22; B07B 4/08; B02C 18/22

(52) U.S. Cl. CPC B07B 11/06; A23N 15/00; B02C 18/2266; B07B 4/08; B07B 1/22

(57) ABSTRACT

The present disclosure is directed to a rotary drum trimming apparatus for trimming plants, in particular, buds and flowers, to remove unwanted plant material. More specifically, the present disclosure is directed to a rotary drum trimming apparatus that incorporates a separator for efficiently separating severed plant material from an airstream that carried the severed plant materials away from a rotary trimming drum

### FIELD OF THE INVENTION

The present disclosure relates to a rotary trimmer for trimming plant materials. More specifically, the present disclosure relates to a rotary trimmer having a separator for separating severed plant material from an air stream, which carries the severed plant material from the rotary trimmer.

### BACKGROUND

Flowers, buds and leaves, etc. (commonly “plant material”) harvested from stemmed plants are often used in oils, medicinal products, aromatherapy, cuisine, perfumes, dyes, toilet preparations, tinctures, distillation products (e.g., steam distillation of lavender oil), smoking products, and/or the like. Methods are known for cutting, chipping, trimming, and grinding plant materials for a variety of purposes. One type of machine for trimming plant material utilizes a perforated rotating drum (e.g., cylindrical drum) to tumble plant material as the plant material passes through a hollow interior of the rotating drum. Directly adjacent to the drum, are one or more cutting blades (e.g., stationary and/or rotating), which cut plant material that extends through the perforations/apertures as the drum is rotating. In some drum-type trimming machines, a suction force is provided assist in extending plant material through the apertures. Such a suction force may, in addition, remove the trimmed material from the device for collection.

### SUMMARY

Provided herein is a trimming device for trimming plant material. The trimming device utilizes a rotating drum through a hollow interior of which plant material, such as flowers and buds, passes while being trimmed. Disposed against an outside surface of the rotating drum are one or more cutting elements (e.g., fixed or rotating) that cut or trim (e.g., severs) leaves and or other material that extend through a perforated surface of the drum. A vacuum or airflow system is utilized to remove the material severed from the plant materials within the rotating drum. Aspects of the presented disclosure are directed towards a separation system utilized in conjunction with such a rotating drum trimmer.

In an aspect, a plant processing device includes a rotary trimmer having a rotating trimming drum a long axis of which defines a horizontal reference axis of the device. The rotating drum is typically disposed within a housing through which air may be forced and/or drawn. Disposed vertically below the rotary trimmer (e.g., below the horizontal reference axis) is a separator assembly that including one or more separators. In an arrangement, the separator assembly may be positioned such that plant material trimmed from within the rotating drum may fall directly into the assembly. In one arrangement, the separator assembly includes at least a first separator that imparts a radial flow to an airstream flowing through the separator to impart centrifugal forces to severed plant material in the airstream. Such centrifugal forces allow for separating the plant material from air in the airstream. In another arrangement, the separator assembly includes at least a first separator that directs an airstream to make one or more sudden changes in direction. In such an arrangement, plant materials may not follow the airstream in the sudden changes of direction allowing the plant material to be separated from the airstream. In any arrangement, such an airstream may be drawn through the separator via one or more vacuum sources connected to an outlet of the separator, which is fluidly connected to an interior of the rotary trimmer. In an arrangement, the separator includes an outer cylindrical sidewall that extends between a top surface and a bottom surface of the separator. An inlet extends through the outer sidewall or a top surface of the separator to introduce an airstream, including air and severed plant material, along an inside surface of the outer cylindrical sidewall. In such an arrangement, movement of the airstream along the inside surface imparts a radial flow to the air stream. A severed material outlet extends through either the outer cylindrical sidewall or bottom surface of the separator to capture severed plant material from the radial flow of the airstream. A separator air outlet allows air to exit the separator from a central portion thereof.

In an arrangement, the separator includes an outer cylindrical sidewall where a central axis of the cylindrical sidewall is substantially perpendicular to the horizontal reference axis of the rotating drum. In a further arrangement, the separator includes an inner cylindrical sidewall that may be concentrically disposed within the outer sidewall. In an arrangement, fluid flows from an inlet through an annulus between the inner and outer sidewalls. In a further arrangement, the flow path through the separator is at least partially helical between the top surface and a bottom surface of the separator. In such an arrangement, severed plant material may pass through an aperture in the floor or bottom surface of the separator while air of the airstream substantially free of plant material may pass through an interior of the inner cylindrical sidewall.

### BRIEF DESCRIPTION OF THE DRAWINGS

FIGS. 1A and 1B are first and second perspective views of a rotary drum plant processing device.

FIGS. 2A-2D show various views of rotary plant trimmer.

FIGS. 3A and 3B illustrates first and second perspective views of a separator assembly.

FIG. 3C illustrates a bottom plate of the separator assembly.

FIG. 4A illustrates one embodiment of a cyclonic separator.

FIG. 4B is a transparent view of the cyclonic separator of FIG. 4A.

FIG. 5 illustrates a cross-section view of the cyclonic separator.

FIG. 6 illustrates a portion of a collection assembly for use with the rotary drum plant processing device.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

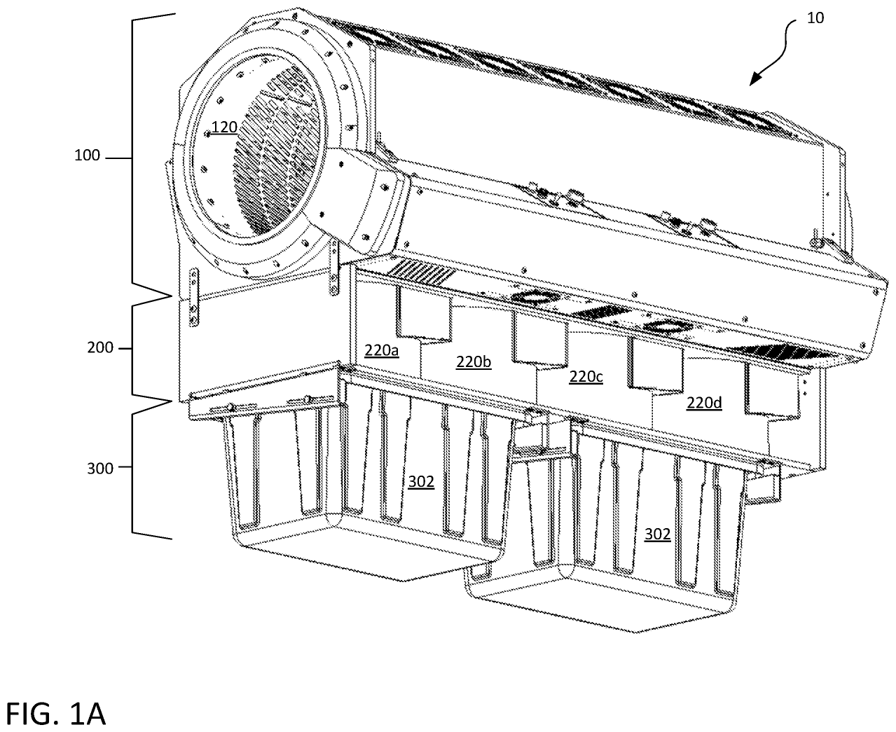

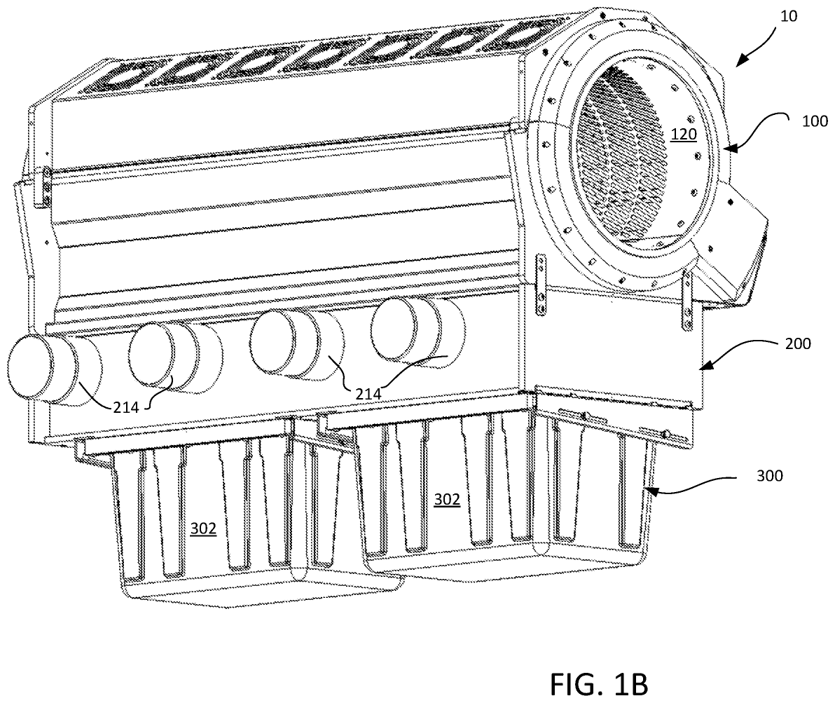

The presented disclosure is broadly directed to a plant trimming and separation system 10 used to trim and collect various plant materials. FIGS. 1A and 1B illustrate first and second perspective views of the plant trimming and separation system 10. In one application, the plant trimming system 10 separates leaves from harvested plant materials, including ingestible or otherwise consumable plant materials. The remaining portion of the harvested plant material may be a flowering or body portion of the plant (e.g., bud) from which leaves may be separated. The separated leaves and/or the remaining portion may be used in a variety of applications. The plant trimming and separation system 10 includes two primary components, a plant trimmer assembly 100 and a separator assembly 200. The system may also include a collection assembly 300.

The plant trimmer assembly 100 (hereafter ‘plant trimmer’) separates leaves of the plant material by severing the leaf (or a stem or other member connecting a remaining portion of the plant material) between two components. In the illustrated embodiment, a rotating drum 120 may receive plant materials containing leaves and a flowering portion or bud within its hollow interior. Rotation of the drum 120 in a first direction may cause leaves to extend through a perforated sidewall of the rotating drum 120. In some embodiments, a second rotating cutting element, such as a helical blade (not shown) may be positioned to engage an outside surface of the drum 120. Rotation of the cutting element in a second direction, opposite the first direction, causes the drum and cutting element to exert opposing forces on portions of the leaves or other material extending through perforations in the drum 120. This causes the leaves to be severed by the drum 120 and engaging abutting cutting element. In some embodiments, the drum and cutting element may rotate in the same direction at different speeds. In other embodiments, the cutting element may be a non-rotating blade, such as a bed-knife. In any embodiment, the rotation of the drum relative to the cutting element allows the plant trimmer to sever leaves disposed between the drum and cutting element thereby separating a portion of the leaf from the plant material within the interior of the drum.

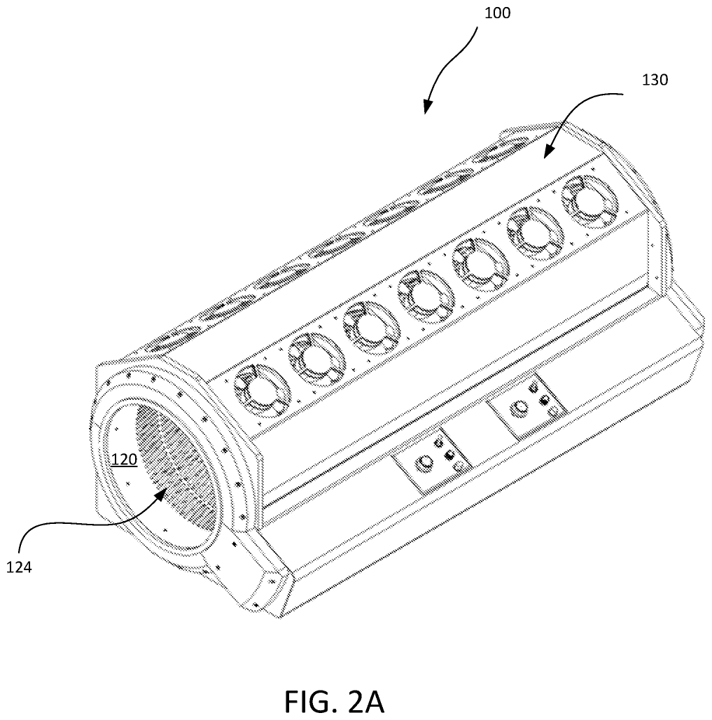

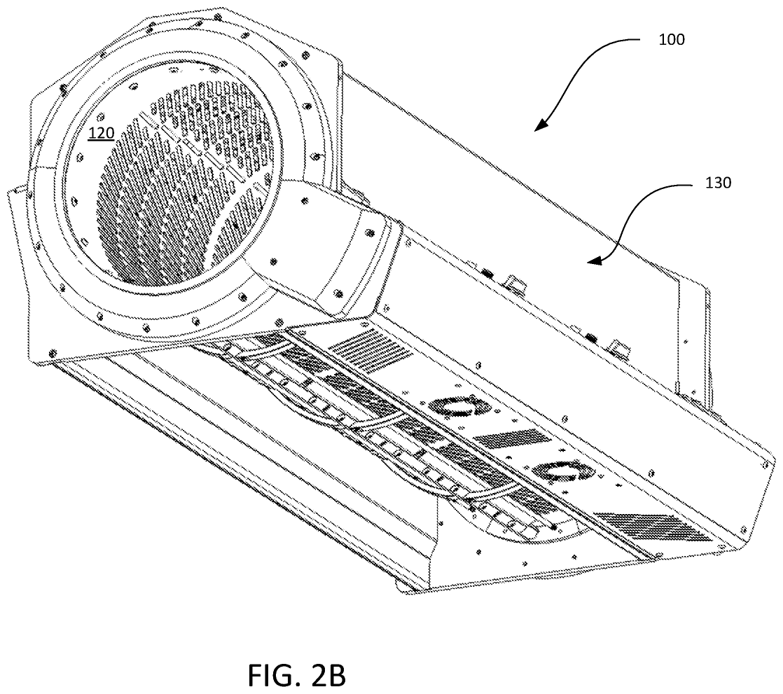

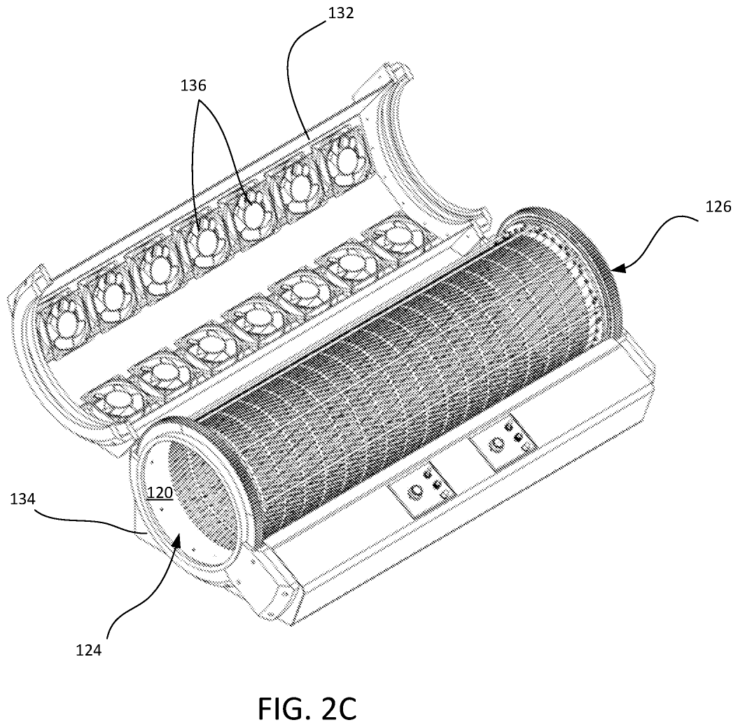

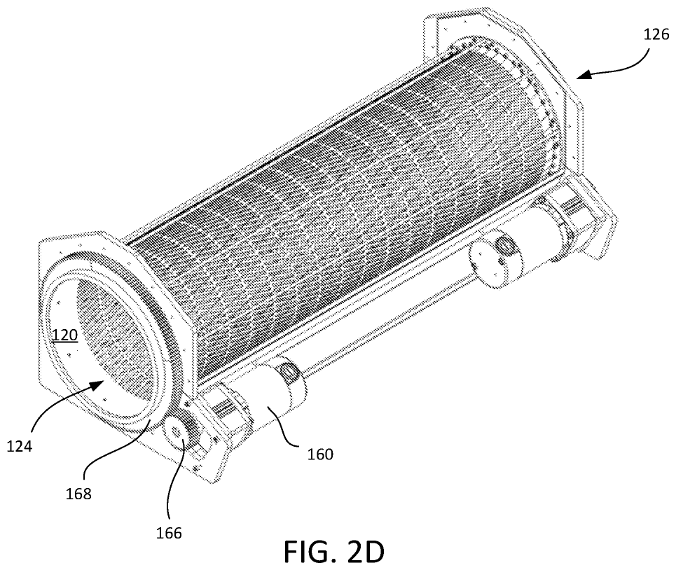

As variously illustrated in FIGS. 2A-2D, which illustrate the plant trimmer 100 removed from the remainder of the system, the plant trimmer 100 includes the generally cylindrical drum 120 configured to about its longitudinal axis by a drum drive 160. In this regard, the plant trimmer may include one or more electric motors that impart a rotation to the drum 120 and, if utilized, a rotary shearing device. In an embodiment, a gear 166 disposed on the shaft of an electric motor engages a mating gear 168 disposed about the periphery the drum 120.

Plant material containing plant material may be fed into front end 124 of the drum whereby operation of the trimmer 100 causes the plant material migrate through the drum 120. While disposed within the drum 120, portions (e.g., leaves) of the plant material can project through slots or perforations in the drum 120 where these portions are trimmed/cut from the plant material within the drum by, for example, a rotary shearing mechanism and/or a fixed bed-knife. After passing through the drum 120, trimmed plant materials exit through the rear end 126 of the drum.

In the illustrated embodiment, the rotary drum is disposed within a housing 130 that surrounds upper and side portions of the drum 120 and cutting devices (not shown). In the illustrated embodiment, the housing 130 includes an upper shroud 132 that extends over the top half of the drum 120 and engages a lower shroud 134 that extends along the sides of the drum 120. See, e.g., FIG. 2C. The upper shroud 132 may further include a plurality of fans 136 that are configured to blow air into the device. That is, such fans 136 may provide a positive airflow into the interior of the trimmer and drum during operation. In the illustrated embodiment, the lower end or bottom surface of the lower shroud 134 is a generally open surface to interface with and upper end of the separator assembly 200. See. FIGS. 2b and 1A. Once leaves are trimmed from the plant material within the interior of the drum 120, severed plant material may fall through and/or be drawn through the open bottom surface of the lower housing, as is more fully discussed herein.

When the device 10 is assembled, the entirety of the drum 120 and cutting element(s) may be fully encased within the housing 130 which at least partially defines a manifold. Airflow provided by the fans apply positive pressure into the trimmer 100. A vacuum source (not shown) provides negative pressure (e.g., draw pressure) to the lower end of the trimmer 100 may improve disposition of leaves through slots of the perforated drum. This airflow may additionally remove severed plant material from the device. For instance, as plant materials within the drum are trimmed, severed plant materials can be captured within a low pressure region and/or drawn into the vacuum system. In the illustrated embodiment, the system 10 includes a plurality of vacuum ports or outlet ducts 214 in the separation assembly 200 that may be attached to a vacuum source. See FIG. 1A. The vacuum ports are in fluid communication with the interior of the housing 130. Once the outlet ducts are connected to a vacuum source, air may be withdrawn from the interior of the housing 130 to draw severed plant material out of the trimmer 100 in an outlet airstream. Exemplary rotary drum type trimmers are set forth in co-owned U.S. Pat. No. 8,757,524 and co-owned U.S. Patent Publication No. 2019/0297782, the entire contents of each of which is incorporated herein by reference.

The plant material (e.g., leaves) severed from the plant material passing through the interior of the rotary drum is often captured for further processing. That is, the severed plant material is not a waste product. Accordingly, it is desirable to separate this material from the outlet airflow for subsequent processing. Aspects of the present disclosure are based on the realization that capturing and separating the severed plant material provides a number of difficulties. By way of example, the severed plant material is not dry and often contains various oils. Accordingly, such material can clog a vacuum source. Further, it may be desirable to periodically clean plant residues from the device (e.g., daily) to prevent growth of molds and mildews that could potentially contaminate subsequently processed plant materials. Such cleaning is difficult in systems where the severed plant materials pass through conduits of a vacuum system. That is, cleaning the interiors of such conduits is difficult especially when such conduits are baffled or accordion-type conduits.

The presented disclosure addresses these and additional difficulties by inserting the separator assembly 200 between the plant trimmer 100 and a vacuum source. The separator assembly 200 is configured to remove a majority of severed plant material from the airstream exiting the device before the airstream reaches the vacuum source. In various embodiments, the separator assembly removes 95% of severed plant material from the outlet airstream. In additional embodiments, the separator assembly removes 97% or even 99% of the severed plant material from the outlet airstream. Such an arrangement reduces or eliminates clogging of the vacuum source. Further, as the severed plant material is separated and collected prior to passing through conduits of the vacuum source, these conduits do not need to be cleaned. Of note, the plant trimmer 100 and separator assembly 200 are discussed herein as being separate components that are selectively connectable. While such a ‘two-piece’ configuration is believed beneficial for assembly, disassembly and/or cleaning, it will be appreciated that the plant trimmer and separator assembly may be combined as a single component.

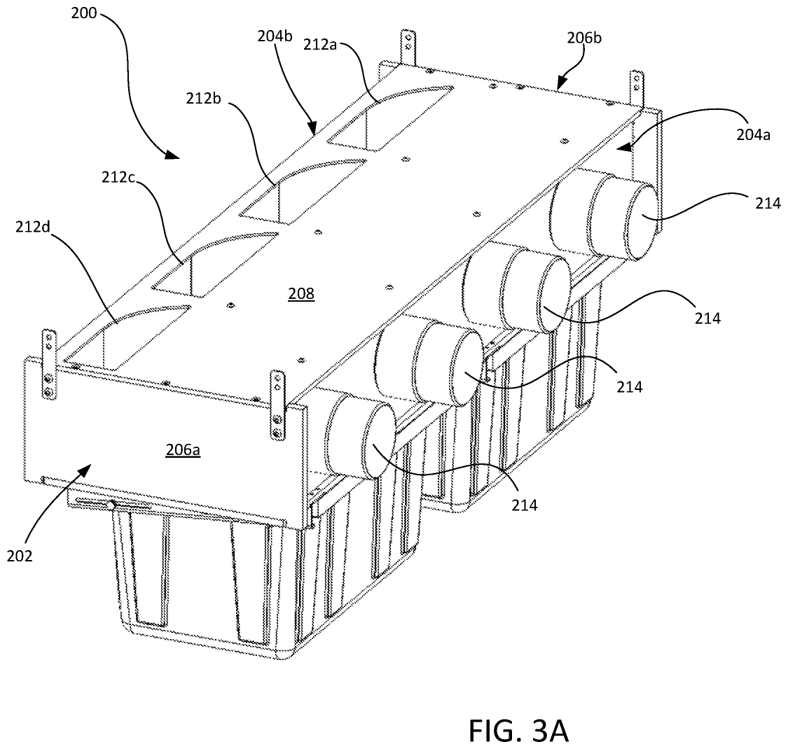

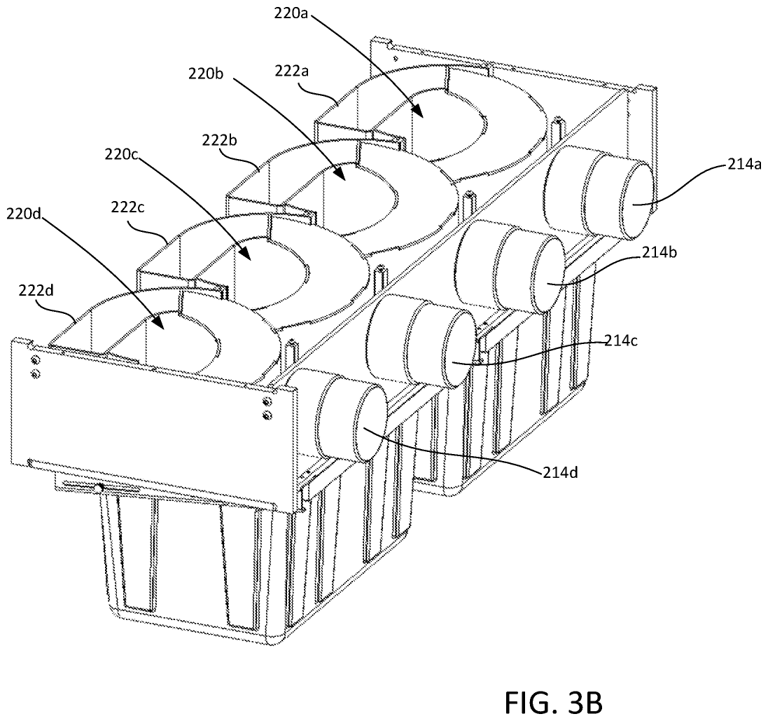

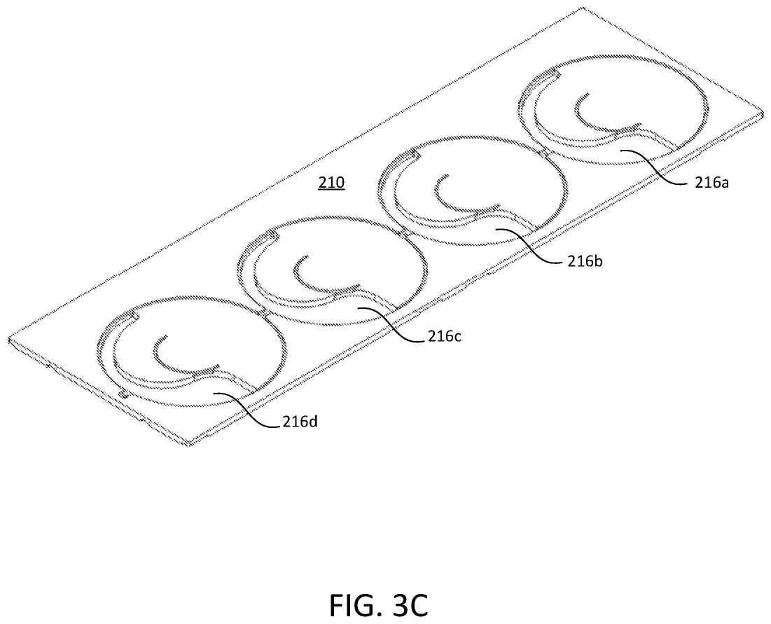

As illustrated in FIGS. 1A, 2B and 3A-3C, an upper surface of the separator assembly 200 engages the open bottom end of the housing 130. As illustrated, the separator assembly 200 includes a separator housing 202 that houses a plurality of individual separators 220a-d (hereafter 220 unless specifically referenced). The separator housing 202 includes two generally parallel side surfaces or sidewalls 204a, 204b (204b not shown in FIGS. 1A and 3B for purposes of illustration), which extend between front and rear end plates or end walls 206a, 206b. In the illustrated embodiment, a top plate 208 extends over the upper edges of the sidewalls and end walls. A bottom plate 210 extends between the lower edges of the sidewalls and end walls. See, e.g., FIG. 3C. The sidewalls, end walls, top plate and bottom plate defined a generally closed interior of the separator housing 202 in which the separators 220 are disposed. Though the top plate and bottom plate are discussed as being components of the separator housing 202, it will be appreciated that these components may be portions of the mating plant trimmer 100 and collection assembly 300, respectively, or separate components disposed therebetween. What is important is that and interior of the separator housing 202 may be substantially sealed once the device 10 is assembled to permit drawing air through the separators by one or more vacuum sources. Of note, the term “substantially sealed” does not require that the housing be hermetically sealed. Rather, it is sufficient that a majority of the airflow through the separator assembly be drawn from the interior of the plant trimmer even if some air is drawn through various interfaces between the separator assembly and mating components (e.g., collection assembly).

To permit drawing air through the interior of the separator housing 202 and, by way of extension, through the separators 220 and the plant trimmer 100, the illustrated embodiment of the separator 200 includes a plurality of vacuum ducts or outlet ducts 214 that open through one of the sidewalls 204b into the interior of the housing. Each outlet duct 214 may be attached to a vacuum source. Alternatively, one or more of the outlet ducts may be capped. As is more fully discussed below, upon applying vacuum to the outlet ducts, an airflow is drawn from the interior of the plant trimmer. The airflow passes through one or more separators removing plant material from the airflow. The airflow then passes into an interior of the separator housing and out the outlet duct(s). Variation is possible. For instance, each separator could be directly connected to a vacuum source such that the airflow does not enter into an interior of a separator housing.

As previously noted, a plurality of separators 220 are disposed within the separator housing 202. The use of a plurality of separators 220 permits positioning of the separators along the length of the plant trimmer 100 beneath the rotary drum. In the illustrated embodiment, the individual separators 220 are disposed in a 1×4 array. However, it will be appreciated that other configurations are possible (e.g., 2×4 array, irregular etc.). Further, it will be appreciated in alternate embodiments, a single separator may be utilized. As illustrated, the separator assembly 200 is disposed directly below (e.g., vertically below) the bottom open end of the housing 130. In such an arrangement, severed plant material may proceed directly from the plant trimmer 100 into the separator assembly 200 without passing through conduits of a vacuum source. Further, disposition vertically below the plant trimmer allow at least a portion of the severed plant material to fall directly into the separator assembly (e.g., under the force of gravity).

As illustrated, each separator 220a-d has an inlet opening 222a-d that is disposed adjacent to a corresponding opening 212a-d in the plate 208 that is disposed between the top surface of the separator housing 202 and below the open bottom surface of the plant trimmer 100. In the illustrated embodiment, the plate 208 includes four inlet apertures 212a-d (hereafter 212 unless specifically referenced) that open to inlets 222a-d (hereafter 222 unless specifically referenced) of the four separators 220a-d (hereafter 220 unless specifically referenced). In operation, an airstream drawn by a vacuum source attached to one or more of the outlet ducts 214 passes through the interior of the plant trimmer into the inlet of the separator(s) 220 passing around an interior surface of the separator, into the interior of the separator housing 202 and out the outlet duct 214. The airstream also carries severed plant material from the interior of the plant trimmer 100 into the interior(s) of the separator(s) 220. Passage of the airstream through the separator(s) 220 removes severed plant material from the airstream such that the airstream passing out of the outlet duct 214 is substantially free of the severed plant material. That is, 95% or more of the plant material may be removed from the airstream between the separator inlet and the outlet duct 214.

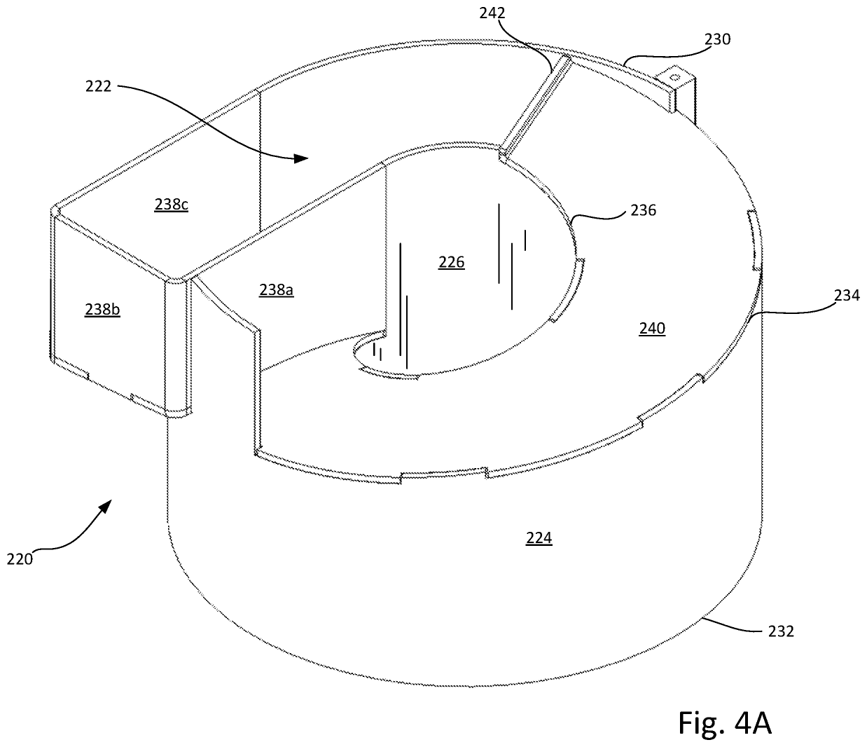

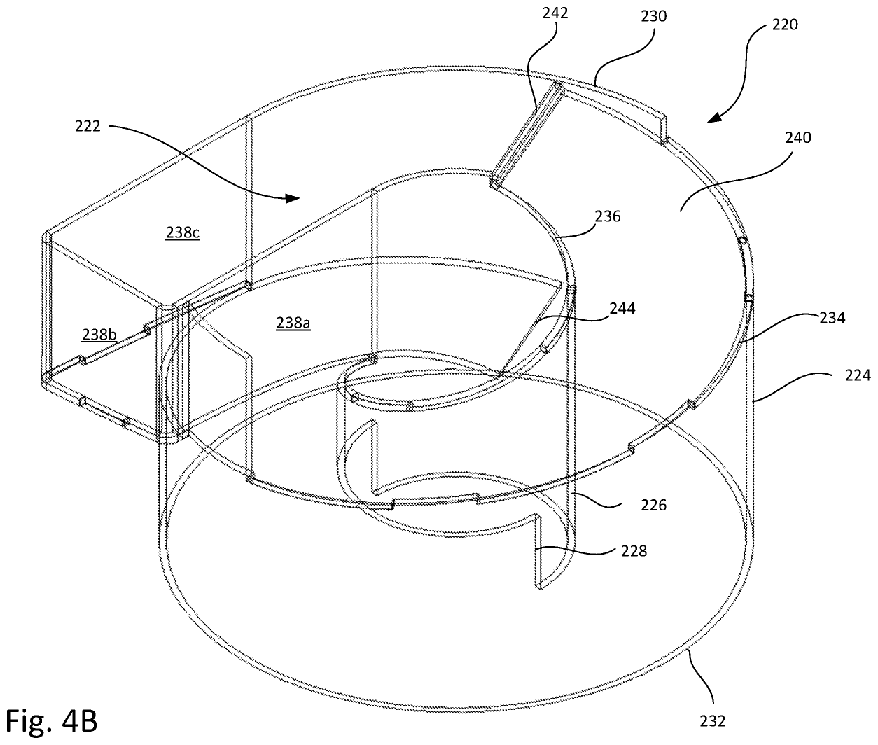

It will be appreciated that any airflow separator may be utilized to separate the plant material from the airstream. Such separators include baffle-type separators, which cause sudden directional changes to an airstream passing through the separator. Such sudden changes in direction utilizes momentum of the plant material to separate the plant material from the airflow. In another embodiments, centrifugal and/or cyclonic separators may be utilized. In the illustrated embodiment, the separators 220 utilize centrifugal force as a primary means for separating the severed plant material from the airstream being drawn out of the plant trimmer. In this regard, the separators 220 may be referred to as a centrifugal or cyclonic separators. FIGS. 4A and 4B illustrates one embodiment of a separator 220 in accordance with the present disclosure. In FIG. 4B, the separator is shown as being made of transparent material for purposes of illustration. However, it will be appreciated that this is not a requirement. Generally, each separator 220 includes a cylindrical outer sidewall 224. In the illustrated embodiment, a bottom edge 232 of the cylindrical outer sidewall 224 is disposed in a common plane and is configured for abutment against and/or attachment to a generally planar top surface of the bottom plate 210. The cylindrical outer sidewall 224 defines an outer cylinder, which in the present embodiment is a vertical cylinder having a central axis that is generally transverse to a centerline axis (e.g., horizontal axis) of the rotating drum of the plant trimmer. The separator 220 also includes a cylindrical inner sidewall 226. In the illustrated embodiment, the cylindrical inner sidewall 226 is concentric with the outer sidewall 224 such that an annulus is formed between the sidewalls. A portion of the bottom edge of the inner sidewall 226 is configured for abutment and/or attachment with the top surface of the bottom plate 210 of the housing 202. In the illustrated embodiment, the bottom edge of the inner sidewall 226 includes a cut-out or opening 228 (e.g., air exit aperture). This cut-out or opening 228 provides a path for air entering into the separator 220 through a separator inlet 222 to exit the separator through a hollow interior of the cylindrical inner sidewall 226.

The airflow passes through the separator inlet 222 and into the annulus between the outer sidewall 224 and the inner sidewall 226 at a position near the top edge of the separator. The physical configuration of the interior of the separator 220 between the cylindrical sidewalls 224, 226 causes the plant material-bearing airstream to rotate around the inside wall of the outer sidewall 224 as the airflow passes downward around the interior of the separator 220 to the air outlet 228 in the lower edge of the cylindrical inner sidewall 226. The resulting centrifugal force pushes the plant material radially outward against the inside surface of the outer cylindrical sidewall 226 as it rotates. In addition to being propelled by the airflow, gravity pulls the plant material downward to a collection aperture in the bottom of the annulus between the cylindrical sidewalls. That is, the plant material passes through a collection aperture 216 in the bottom plate 210 of the separator housing 202. The plant material falls through the aperture into a collection receptacle while the air of the airstream (e.g., now substantially free of severed plant material) continues through the interior of the inner sidewall 226 to and interior of the housing 202 and through and outlet duct 214 connected to a vacuum source.

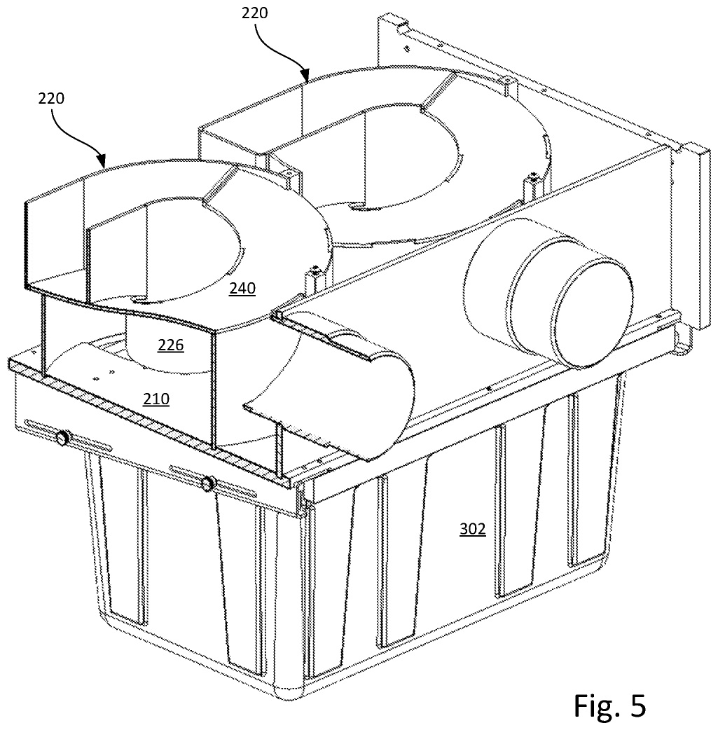

In the illustrated embodiment, the flow path through the interior of the separator 200 is generally a downward spiraled or helical path from a top edge 230 of the separator 220 to a bottom edge 232 of the separator 220 around the inside surface of the outer cylinder 226. Such a helical path, though not strictly required, facilitates the formation of a high efficiency low profile separator that may be disposed directly below the plant trimmer. As illustrated in FIGS. 4A, 4B and 5, the helical path is formed using a helical plate 240 that connects between the upper edges of the outer cylinder 224 and the inner cylinder 226. That is, the helical plate 240 extends over the annulus formed between outer cylinder 224 and the inner cylinder 226. The helical plate 240 extends from an end of the separator inlet opening 222 and spirals downward along the correspondingly downward spiraling edge surfaces 234, 236 of the outer cylinder 224 and inner cylinder 226, respectively. In this embodiment, the outer and inner cylindrical sidewalls include irregular upper edges. That is, the upper edges of the cylindrical elements are not planar. In the illustrated embodiment, the helical plate 240 extends from a front edge 242 connected to the end of the separator inlet 222 for approximately one half turn (e.g., 180 degrees) until it meets the lower end of an inlet opening sidewall 238a, which extends downward from the inlet opening 222. As shown, the separator inlet includes three downwardly extending sidewalls 238a-238c that form an open ended enclosure that receives airflow from the plant trimmer. In the illustrated embodiment, the helical plate 240 extends under the separator sidewall 238a forming a downward sloping floor beneath a portion or an entirety of the separator inlet opening 222 until the helical plate 240 terminates at a rear edge 244. The physical configuration of the inlet 222 in conjunction with the curving inside surface of the outer cylinder 226 work to direct the airflow tangentially around the inside surface of the separator 220. That is, these components impart a radial flow to the airstream passing through the separator.

To collect the severed plant material from the separator 220, the bottom plate 210 disposed below the four separators 220a-d includes four aperture 216a-d that are disposed along the inside bottom edge of the outer sidewalls 224 of the separators. In the illustrated embodiment, each aperture 216 is an elongated and arcuate aperture that extends around approximately one-half of the outer sidewall. Referring to FIGS. 3C and 4B, when plant matter passes into the separator inlet 222, the airstream is directed radially around the inside surface of the outer sidewall 224 as well as downward by the helical plate 240. The severed plant material in the airstream moves outward due to centrifugal forces and falls downward due to gravity as well as at least being directed downward by the helical plate. Once the plate material passes the floor surface of the separator inlet (e.g., rear edge 244 of the helical plate 240) the plant material falls to the floor of the separator 220 (See. FIG. 4B), which is formed by the bottom plate 210. See. FIG. 3C. At this time, the severed plant material falls through the elongated arcuate aperture 216 while the airflow continues around the inside of the separator eventually exiting trough the opening 228 in the inner sidewall 226.

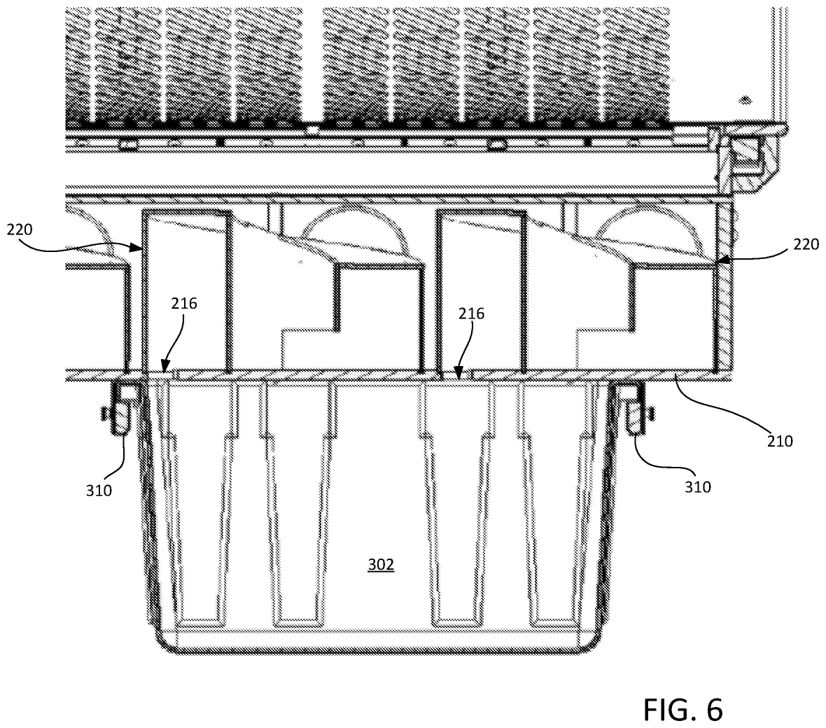

To permit the severed plant material to fall through the aperture 216 in the bottom of the separator without the airflow passing through the aperture 216, the aperture 216 must pass into a substantially sealed area. That is, to prevent drawing air into the separator through the aperture 216, an area under the aperture 216 must restrict the passage of air into the separator. In the presented embodiment, an area below the aperture 216 in the bottom of the separator is substantially sealed by a collection assembly 300. As best illustrated in FIGS. 1A and 6, the collection assembly comprises one or more tubs or collection bins 302 disposed below the bottom surface of the of the bottom plate 210 of the separator assembly. Each collection bin has four sides and closed bottom surface. An upper surface of each collection bin is open. The upper peripheral edge of the bin, defined by the top edges of the four sidewalls, is disposed against the bottom surface of the bottom plate 210. In the illustrated embodiment, two collection bins 302 are each disposed beneath two separators 220 such that the apertures 216 through the bottom surfaces of these separators 220 open into the closed interior of the collection bin 302. However, it will be appreciated that each separator may have a separate collection bin or that a single collection bin may be disposed below all of the separators.

During operation, the airflow drawn by the vacuum source through the interior of the separators, may draw the top peripheral edge of the collection bin 302 against the bottom surface of the bottom plate substantially sealing the interface between the collection assembly 300 and the separator assembly 200. In addition or alternatively, the bins may be physically biased against the bottom plate and/or a sealing gasket may be utilized. In any arrangement, it is important is that an interior of the collection bin may be substantially sealed once the device 10 is assembled to permit drawing air through the separators by one or more vacuum sources rather than through an unsealed interface between the collection bin and the separators (e.g., drawing air through the collection apertures 216). Of note, the term “substantially sealed” does not require that the collection bins be hermetically sealed. Rather, it is sufficient that a majority of the airflow through the separator assembly be drawn from the interior of the plant trimmer even if some air is drawn through an interface between the separator assembly and the collection bin(s). In addition, to adjust the pressure within the trimmer, separator assembly and/or collection bins, any or all of these components may have vents that may be opened (e.g., manually) to introduce air into these components. This may prevent, for example, the collection bins from collapsing under negative pressure. Pressure relive valves could likewise be utilized.

To facilitate the insertion and removal of the collection bin(s) 302 below the separator assembly 200, the presented embodiment utilizes slide assemblies 310 that engages opposing rim surfaces on the upper periphery of the bin 302. The slide assemblies are similar to drawer slides utilized in cabinets. The drawer slides allow the bin to be moved from a position directly below the separator assembly to an open position (not shown) disposed from underneath the separator assembly 200. This allows for removing and replacing the collection bin. Other means of connecting the connection bins to the device are possible.

Other aspects and embodiments of the plant trimming apparatus comprise any one or more feature(s) disclosed herein in combination with any one or more other feature(s) or a variant or equivalent thereof. In any of the embodiments described herein, any one or more features may be omitted altogether or replaced or substituted by another feature disclosed herein or a variant or equivalent thereof. Numerous modifications and changes to the embodiments described above will be apparent to those skilled in the art.

What is claimed is:

1. A plant processing device for trimming plant material, comprising:
a rotary trimmer having a rotating drum for trimming plant material passing through the interior of the rotating drum, the rotary trimmer at least partially disposed within a trimmer housing, wherein a longitudinal axis of the rotating drum defines a horizontal reference axis;
a separator disposed vertically below the rotary trimmer and fluidly connected to the trimmer housing, the separator having:
an outer cylindrical sidewall extending about a vertical axis that is transverse to the horizontal reference axis, the outer sidewall extending between an upper surface of the separator and a lower surface of the separator;
a separator inlet extending through the upper surface to introduce an airstream, comprising air and severed plant material, proximate to an inside surface of the outer cylindrical sidewall, wherein movement of the airstream along the inside surface imparts a radial flow to the airstream;
a severed material outlet extending through the lower surface of the separator proximate to a bottom edge of a portion of the outer cylindrical sidewall to capture severed plant material from the radial flow of the airstream; and
a separator air outlet, configured to allow air of the airstream to exit from an axially central portion of the separator.

2. The device of claim 1, further comprising:
an inner cylindrical sidewall disposed within an interior of the outer cylindrical sidewall, wherein the inlet introduces the airstream in an annulus defined between the inner cylindrical sidewall and the outer cylindrical sidewall.

3. The device of claim 2, wherein the severed material outlet extends through a bottom surface of the annulus.

4. The device of claim 2, wherein the inner cylindrical sidewall further comprises a sidewall opening, wherein air of the airstream passes through the sidewall opening to an interior of the inner cylindrical sidewall.

5. The device of claim 2, further comprising:
a helical top surface extending between an inside surface of a portion of the outer cylindrical sidewall and a portion of an outside surface of the inner cylindrical sidewall, wherein the helical top surface imparts a downward flow to the airstream.

6. The device of claim 5, further comprising:
a helical floor surface extending between an inside surface of a section of the outer cylindrical sidewall and a section of an outside surface of the inner cylindrical sidewall, wherein the helical floor is disposed vertically below the separator inlet.

7. The device of claim 1, further comprising:
a separator housing having an enclosed interior housing the separator.

8. The device of claim 7, wherein the separator housing includes:
a housing inlet connected to an outlet on a bottom surface of the trimmer housing; and
a housing outlet duct connectable to a vacuum source, wherein the separator is disposed between and the housing inlet and the housing outlet duct.

9. The device of claim 8, wherein the separator inlet is in fluid communication with the housing inlet.

10. The device of claim 8, wherein the outlet duct is in fluid communication with the separator air outlet.

11. The device of claim 1, further comprising:
a plurality of separators disposed vertically below the rotary trimmer and fluidly connected to the trimmer housing.

12. The device of claim 11, wherein the plurality of separators are disposed in an array below the rotary trimmer.

13. The device of claim 1, further comprising:
a collection bin disposed below the severed material outlet extending through the lower surface of the separator.

14. A plant processing device for trimming plant material, comprising:
a rotary trimmer having a rotating drum for trimming plant material passing through the interior of the rotating drum, the rotary trimmer at least partially disposed within a trimmer housing, wherein a longitudinal axis of the rotating drum defines a horizontal reference axis;
a separator disposed vertically below the rotary trimmer and fluidly connected to the trimmer housing, the separator having:
an outer sidewall, the outer sidewall extending between a top surface of the separator and a bottom surface of the separator to define an interior of the separator;
a separator inlet extending through one of the outer sidewall and the top surface to introduce an airstream, comprising air and severed plant material, to the interior of the separator, wherein movement of the airstream within the interior of the separator imparts a change in direction to the airstream;
a severed material outlet extending through one of the outer sidewall and the bottom surface of the separator to capture severed plant material from the airstream; and
a separator air outlet, configured to allow air of the airstream to exit from the interior of the separator.

15. The device of claim 14, wherein the outer sidewall is a cylindrical sidewall that extends about a vertical axis that is transverse to the horizontal reference axis.

16. The device of claim 15, wherein an internal flow path through the separator is at least partially a helical flow path.

17. The device of claim 15, further comprising:
a separator housing having an enclosed interior housing a plurality of separators.

18. The device of claim 17, wherein the separator housing includes:
a housing inlet connected to an outlet on a bottom surface of the trimmer housing; and
at least one housing outlet duct connectable to a vacuum source, wherein the plurality of separators are disposed between and the housing inlet and the housing outlet duct.

19. The device of claim 14, further comprising:
at least one collection bin disposed below the severed material outlet extending through the lower surface of the separator.

20. The device of claim 14, wherein a plurality of separators are disposed in an array below the rotary trimmer.
